(19) United States
(12) Patent Application Publication
(10) Pub. No.: US 2011/0095967 A1
(43) Pub. Date: Apr. 28, 2011

(54) PIXEL AND ORGANIC LIGHT EMITTING DISPLAY DEVICE USING THE SAME

(76) Inventor: Sang-Moo Choi, Yongin-city (KR)

(21) Appl. No.: 12/836,549

(22) Filed: Jul. 14, 2010

(30) Foreign Application Priority Data
Oct. 26, 2009 (KR) 10-2009-0101691

(51) Int. Cl. G09G 3/30

(52) U.S. Cl. 345/76

(57) ABSTRACT

A pixel and an organic light emitting device that can display an image having a desired luminance. The pixel includes an organic light emitting diode (OLED), first through third transistors, and a first capacitor. The OLED has a cathode electrode coupled to a second power source. The second transistor controls the current from a first power source to the OLED. The first capacitor has a first terminal coupled to a gate electrode of the second transistor. The first transistor is coupled between a second terminal of the first capacitor and a data line, and turns on when a scan signal is supplied to a scan line. The third transistor is coupled between the gate electrode and a second electrode of the second transistor, and turns on when a control signal is supplied to a control line. The third transistor remains turned on for a longer time than the first transistor.

### CROSS-REFERENCE TO RELATED APPLICATION

This application claims priority to and the benefit of Korean Patent Application No. 10-2009-0101691, filed on Oct. 26, 2009, in the Korean Intellectual Property Office, the entire content of which is incorporated herein by reference.

### BACKGROUND

1. Field

Aspects of the present invention relate to a pixel and an organic light emitting display device using the same and, more particularly, to a pixel and an organic light emitting display device that can display an image having a desired luminance.

2. Description of Related Art

In recent years, various flat panel display devices capable of reducing weight and volume when compared to devices using cathode ray tubes have been developed. Examples of such flat panel display devices include a liquid crystal display device, a field emission display device, a plasma display panel, an organic light emitting display device, etc.

Among the flat panel display devices, the organic light emitting display device displays images by using an organic light emitting diode that generates light by recombining electrons and holes. The organic light emitting display device has relatively rapid response speed and low power consumption.

The organic light emitting display device includes a plurality of pixels that are arranged in a matrix at intersections (crossing regions) of a plurality of data lines, scan lines, and power lines. Each of the pixels is typically constituted by the organic light emitting diode, two or more transistors including a driving transistor, and one or more capacitors.

Such an organic light emitting display device has an advantage in low power consumption, but a disadvantage in that the amount of current that flows to the organic light emitting diode varies depending on a threshold voltage variation (e.g., deviation) of the driving transistor included in each of the pixels, thereby causing display nonuniformity. That is, characteristics of the driving transistor vary depending on variables of a manufacturing process of the driving transistor provided in each of the pixels. In fact, it may be impossible to manufacture all transistors of the organic light emitting display device to have the same characteristic in a conventional process step. Consequently, the threshold voltage variations of the driving transistors result.

In order to solve the problem, a method of adding a compensation circuit including a plurality of transistors and capacitors in each of the pixels has been proposed. The compensation circuit included in each of the pixels charges a voltage corresponding to the threshold voltage of the driving transistor during one horizontal period to thereby compensate the variation of the driving transistor. Here, the display driving is divided up into frames, each frame corresponding to one vertical period (complete refresh of the display), which is in turn divided up into numerous horizontal periods (each corresponding to a refresh of one or more rows).

Meanwhile, recently, driving methods using a frequency of 120 Hz or more have been developed in order to remove a motion blur phenomenon. However, in case of high-speed driving at 120 Hz or more, a charging duration of the threshold voltage of the driving transistor is shortened, such that compensation of the threshold voltage of the driving transistor may no longer be possible during a horizontal period.

### SUMMARY

Accordingly, aspects of embodiments of the present invention are directed toward a pixel and an organic light emitting display device using the same that can compensate a threshold voltage of a driving transistor regardless of a driving frequency. In one embodiment, by using a separate control line per row along with a control line driver, a compensation circuit of the pixel can have sufficient time to charge a threshold voltage by spanning many horizontal periods if necessary.

According to an exemplary embodiment of the present invention, a pixel is provided. The pixel includes an organic light emitting diode (OLED), first through third transistors, and a first capacitor. The OLED has a cathode electrode coupled to a second power source. The second transistor is for controlling an amount of current to the OLED from a first power source. The first capacitor has a first terminal coupled to a gate electrode of the second transistor. The first transistor is coupled between a second terminal of the first capacitor and a data line. The first transistor is configured to be turned on when a scan signal is supplied to a scan line. The third transistor is coupled between the gate electrode and a second electrode of the second transistor. The third transistor is configured to be turned on when a control signal is supplied to a control line. The third transistor is configured to remain turned on for a time longer than a time when the first transistor is configured to be turned on.

The third transistor may be configured to be concurrently turned on with the first transistor.

The pixel may further include fourth and fifth transistors. The fourth transistor is coupled between a reference power source and the second terminal of the first capacitor. The fourth transistor is configured to remain turned on during a part of a period when the third transistor is configured to be turned on. The fifth transistor is coupled between the second transistor and the OLED. The fifth transistor is configured to be turned on and turned off substantially simultaneously with the fourth transistor.

The fourth transistor may be configured to remain turned on during a part of a period when the first transistor and the third transistor are both turned on. The fourth transistor may be configured to be turned off during remaining periods except during a part of a period when the third transistor is configured to be turned off.

The fourth transistor may be configured to be turned on after the third transistor is configured to be turned off.

The pixel may further include a second capacitor coupled between the second terminal of the first capacitor and the first power source.

The second capacitor may have a larger capacitance than the first capacitor.

The pixel may further include a sixth transistor coupled between the second terminal of the first capacitor and an anode electrode of the OLED. The sixth transistor is configured to be turned on and turned off substantially simultaneously with the third transistor.

The first capacitor may have a smaller capacitance than a parasitic capacitance of the OLED.

According to another exemplary embodiment of the present invention, an organic light emitting display device is provided. The organic light emitting display device includes a scan driver, a control line driver, a data driver, and pixels. The scan driver is for sequentially supplying a scan signal to scan lines and sequentially supplying an emission control signal to emission control lines. The control line driver is for sequentially supplying a control signal having a width larger than the scan signal to control lines. The data driver is for supplying data signals to data lines to be synchronized with the scan signal. The pixels are at crossing regions of the scan lines and the data lines. Each of the pixels includes an organic light emitting diode (OLED), first through third transistors, and a first capacitor. The OLED has a cathode electrode coupled to a second power source. The second transistor is for controlling an amount of current to the OLED from a first power source. The first capacitor has a first terminal coupled to a gate electrode of the second transistor. The first transistor is coupled between a second terminal of the first capacitor and one of the data lines. The first transistor is configured to be turned on when the scan signal is supplied to one of the scan lines. The third transistor is coupled between the gate electrode and a second electrode of the second transistor. The third transistor is configured to be turned on when the control signal is supplied to one of the control lines. For a natural number i, the control line driver is configured to supply the scan signal to an i-th scan line of the scan lines and is configured to supply the control signal to an i-th control line of the control lines.

The scan driver may be configured to supply the emission control signal to an i-th emission control line of the emission control lines to partially overlap the scan signal supplied to the i-th scan line. The scan driver may be configured to stop supplying the emission control signal to the i-th emission control line after the control signal to the i-th control line is stopped.

Each of the pixels may further include fourth and fifth transistors. The fourth transistor is coupled between a reference power source and the second terminal of the first capacitor. The fourth transistor is configured to be turned off when the emission control signal is supplied to one of the emission control lines. The fifth transistor is coupled between the second electrode of the second transistor and the OLED. The fifth transistor is configured to be turned off when the emission control signal is supplied to the one of the emission control lines.

Gray level voltages of non-black data signals may be set to voltages higher than a voltage of the reference power source.

A gray level voltage of a black data signal may be set to a voltage lower than a voltage of the reference power source.

Each of the pixels may further include a second capacitor coupled between the second terminal of the first capacitor and the first power source.

The second capacitor may have a larger capacitance than the first capacitor.

Each of the pixels may further include a sixth transistor coupled between the second terminal of the first capacitor and an anode electrode of the OLED. The sixth transistor is configured to be turned on when the control signal is supplied to the one of the control lines.

The first capacitor may have a smaller capacitance than a parasitic capacitance of the OLED.

As described above, according to embodiments of the present invention of a pixel and an organic light emitting display device using the same, it is possible to set a charging duration of a threshold voltage regardless of the width of a scan signal to thereby be applicable to high-speed driving. Further, in exemplary embodiments of the present invention, the threshold voltage of a driving transistor is charged during a period longer than one horizontal period when a scan signal is supplied, thereby displaying an image having uniform luminance. Still further, in some embodiments of the present invention, since a gray level is implemented by using a reference voltage, it is possible to display an image having a desired luminance regardless of a voltage drop of a first power ELVDD.

### BRIEF DESCRIPTION OF THE DRAWINGS

The accompanying drawings, together with the specification illustrate exemplary embodiments of the present invention, and, together with the description, serve to explain the principles of the present invention.

FIG. 1 is a diagram showing an organic light emitting display device according to an embodiment of the present invention.

FIG. 2 is a circuit diagram showing a first embodiment of a pixel shown in FIG. 1.

FIG. 3 is a waveform diagram showing a driving method of the pixels shown in FIG. 2.

FIG. 4 is a circuit diagram showing a second embodiment of the pixel shown in FIG. 1.

### DETAILED DESCRIPTION

Hereinafter, certain exemplary embodiments according to the present invention will be described with reference to the accompanying drawings, simply by way of illustration. As those skilled in the art would realize, the described embodiments may be modified in various ways, all without departing from the spirit or scope of the present invention. Accordingly, the drawings and description are to be regarded as illustrative in nature and not restrictive. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

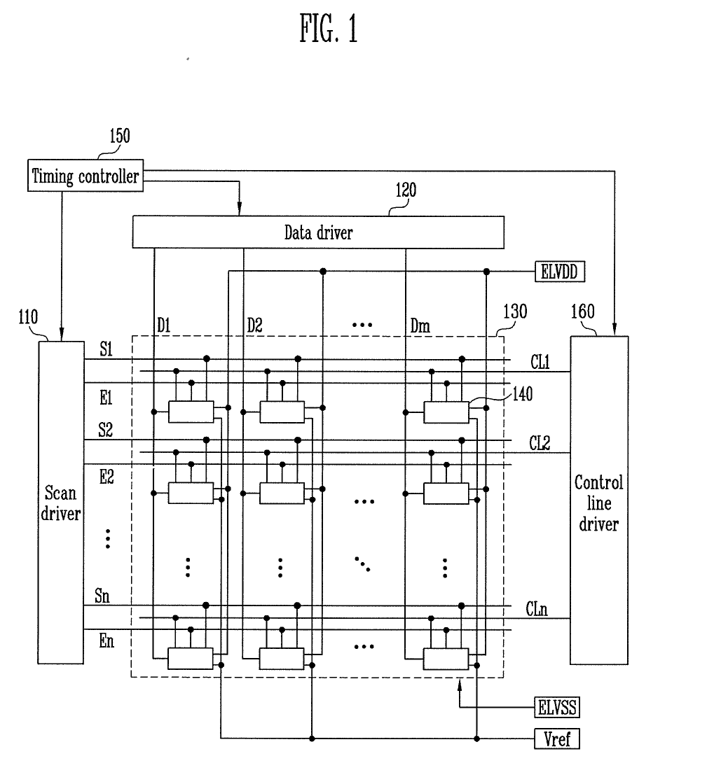

Hereinafter, exemplary embodiments of the present invention will be described in detail with reference to FIGS. 1 to 4 so that those skilled in the art can practice the present invention.

FIG. 1 is a diagram showing an organic light emitting display device according to an embodiment of the present invention.

Referring to FIG. 1, the organic light emitting display device includes pixels 140 that are positioned at intersection portions (crossing regions) of scan lines S1 to Sn, emission control lines E1 to En, control lines CL1 to CLn, and data lines D1 to Dm, a display unit (or display region) 130 including the pixels 140 that are disposed in a matrix, a scan driver 110 for driving the scan lines S1 to Sn and the emission control lines E1 to En, a data driver 120 for driving the data lines D1 to Dm, a control line driver 160 for driving the control lines CL1 to CLn, and a timing controller 150 for controlling the scan driver 110, the data driver 120, and the control line driver 160.

The control line driver 160 sequentially supplies a control signal to the control lines CL1 to CLn. Herein, the control signal supplied to an i-th control line CLi (where i is a natural number) overlaps a scan signal supplied to an i-th scan line Si. The pixels 140 receiving the control signal are charged with voltage corresponding to a threshold voltage of a driving transistor during a period when the control signal is supplied. Meanwhile, in each of the pixels 140, the control signal is set to have a width larger than that of the scan signal to stably compensate the threshold voltage of the driving transistor. In one embodiment, the control signal is made sufficiently long to charge the threshold voltage. In one embodiment, it can even span several horizontal periods.

The scan driver 110 sequentially supplies an emission control signal to the emission control lines E1 to En while sequentially supplying the scan signal to the scan lines S1 to Sn. Herein, the emission control signal supplied to an i-th emission control line Ei partially overlaps the scan signal supplied to the i-th scan line Si. For example, the emission control signal supplied to the i-th emission control line Ei is started after the scan signal supplied to the i-th scan line Si is started, but before the scan signal to the i-th scan line Si is stopped. In addition, supplying the emission control signal to the i-th emission control line Ei is stopped after supplying the control signal to the i-th control line CLi is stopped.

The data driver 120 supplies data signals to the data lines D1 to Dm in synchronization with the scan signal supplied to the scan lines S1 to Sn.

The timing controller 150 controls the scan driver 110, the data driver 120, and the control line driver 160 to correspond to synchronization signals supplied from the outside.

The display unit 130 includes the pixels 140 formed at intersection portions (crossing regions) of the scan lines S1 to Sn and the data lines D1 to Dm. Each of the pixels 140 receives first power ELVDD, second power ELVSS, and reference power Vref from the outside. Each of the pixels 140 controls an amount of current supplied from the first power ELVDD to the second power ELVSS via an organic light emitting diode OLED to correspond to the data signal.

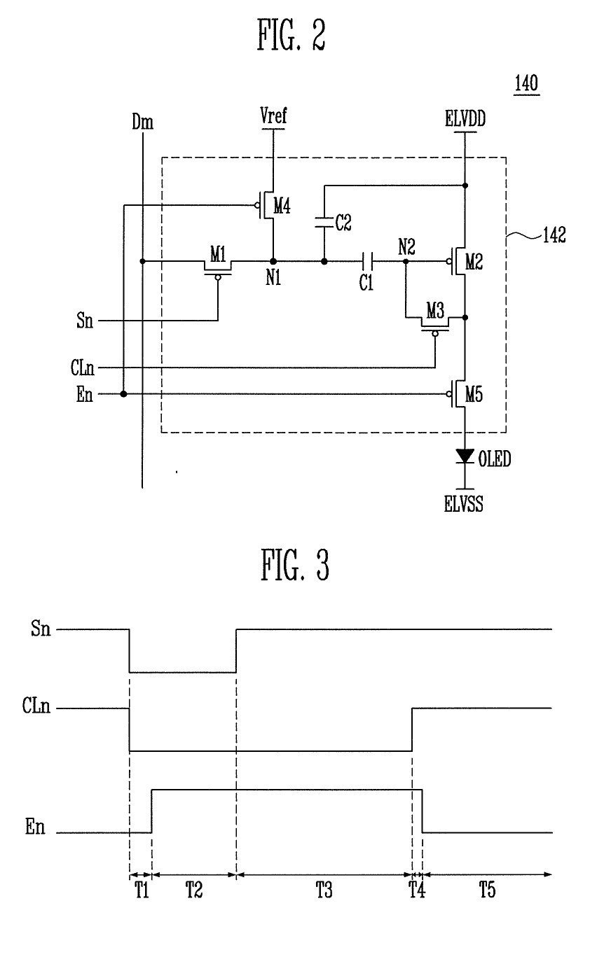

FIG. 2 is a circuit diagram showing a first embodiment of a pixel shown in FIG. 1. In FIG. 2, a pixel connected to an n-th scan line Sn and an m-th data line Dm is shown for convenience of description.

Referring to FIG. 2, the pixel 140 includes an organic light emitting diode OLED and a pixel circuit 142 for controlling the amount of current supplied to the organic light emitting diode OLED.

The organic light emitting diode OLED generates light having a set or predetermined luminance to correspond to the amount of current supplied from the pixel circuit 142. For example, the organic light emitting diode OLED generates red, green, or blue light having the set or predetermined luminance to correspond to the amount of current supplied from the pixel circuit 142. An anode of the organic light emitting diode OLED is connected to the pixel circuit 142. A cathode of the organic light emitting diode OLED is connected to a power source of the second power ELVSS.

The pixel circuit 142 receives the data signal when the scan signal is supplied to the scan line Sn and charges voltage corresponding to a threshold voltage of a second transistor M2 (that is, a driving transistor) during a period when the control signal is supplied to the control line CLn. For this, the pixel circuit 142 includes first to fifth transistors M1 to M5, a first capacitor C1, and a second capacitor C2.

A first electrode of the first transistor M1 is connected to the data line Dm, and a second electrode of the first transistor M1 is connected to a first node N1. In addition, a gate electrode of the first transistor M1 is connected to the scan line Sn. The first transistor M1 is turned on when the scan signal is supplied to the scan line Sn to electrically connect the first node N1 with the data line Dm.

A first electrode of the second transistor M2 is connected to the first power ELVDD, and a second electrode of the second transistor M2 is connected to a first electrode of the fifth transistor M5. In addition, a gate electrode of the second transistor M2 is connected to a second node N2. The second transistor M2 supplies current corresponding to a voltage applied to the second node N2 to the first electrode of the fifth transistor M5. That is, the second transistor M2 is for controlling the amount of current to the organic light emitting diode OLED from the first power ELVDD.

A second electrode of the third transistor M3 is connected to the second node N2, and a first electrode of the third transistor M3 is connected to the second electrode of the second transistor M2. In addition, a gate electrode of the third transistor M3 is connected to an n-th control line CLn. The third transistor M3 is turned on when the control signal is supplied to the control line CLn to diode connect the second transistor M2.

A first electrode of the fourth transistor M4 is connected to the first node N1, and a second electrode of the fourth transistor M4 is connected to a reference power Vref. In addition, a gate electrode of the fourth transistor M4 is connected to an n-th emission control line En. The fourth transistor M4 is turned off when the emission control signal is supplied and turned on when the emission control signal is not supplied.

The first electrode of the fifth transistor M5 is connected to the second electrode of the second transistor M2, and a second electrode of the fifth transistor M5 is connected to the anode electrode of the organic light emitting diode OLED. In addition, a gate electrode of the fifth transistor M5 is connected to the emission control line En. The fifth transistor M5 is turned off when the emission control signal is supplied to the emission control line En and turned on when the emission control signal is not supplied.

The first capacitor C1 is formed between the first node N1 and the second node N2. The first capacitor C1 is charged with a voltage between the first node N1 and the second node N2. Here, a first terminal of the first capacitor C1 is connected to the gate electrode of the second transistor M2 at the second node N2. A second terminal of the first capacitor C1 is connected to the second electrode of the first transistor M1 and the first electrode of the fourth transistor M4 at the first node N1.

The second capacitor C2 is formed between the first node N1 and a power source of the first power ELVDD. The second capacitor C2 is connected to the second terminal of the first capacitor C1. The second capacitor C2 is charged with a voltage between the first node N1 and the power source of the first power ELVDD. Herein, the second capacitor C2 is formed to have a larger capacitance than that of the first capacitor C1. A detailed description thereof will be described below.

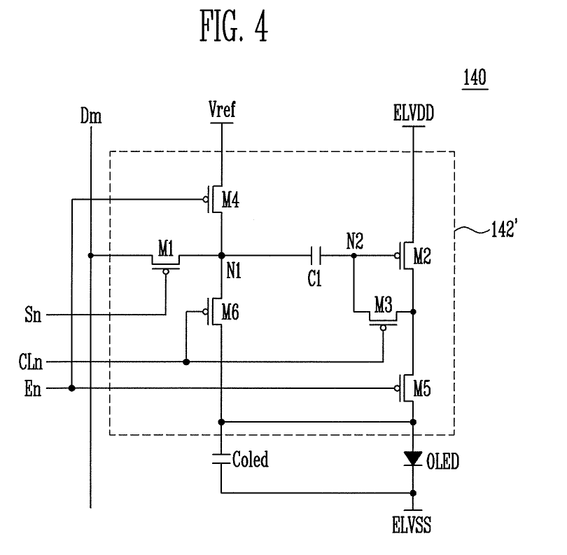

FIG. 3 is a waveform diagram showing a driving method of the pixels shown in FIG. 2. Here, this waveform diagram may also be used to drive a pixel of FIG. 4 described in more detail later.

Referring to FIGS. 2 and 3, during a first period T1, first, the control signal is supplied to the control line CLn while the scan signal is supplied to the scan line Sn. When the scan signal is supplied to the scan line Sn, the first transistor M1 is turned on. When the first transistor M1 is turned on, the data signal from the data line Dm is supplied to the first node N1.

When the control signal is supplied to the control line CLn, the third transistor M3 is turned on. When the third transistor M3 is turned on, the second transistor M2 is diode connected. Meanwhile, during the first period T1, since the fifth transistor M5 remains turned on, the voltage of the second node N2 is initialized to substantially a voltage of the second power ELVSS.

During a second period T2, the emission control signal is supplied to the emission control line En. When the emission control signal is supplied to the emission control line En, the fourth transistor M4 and the fifth transistor M5 are turned off.

When the fourth transistor M4 is turned off, the first node N1 is set to the voltage of the data signal. When the fifth transistor M5 is turned off, electrical connection between the second node N2 and the organic light emitting diode OLED is blocked. Accordingly, since the second transistor M2 is diode connected, the voltage of the second node N2 increases up to a value corresponding to subtracting the threshold voltage of the second transistor M2 from the voltage of the first power ELVDD.

During a third period T3, supplying the scan signal to the scan line Sn is stopped. When supplying the scan signal to the scan line Sn is stopped, the first transistor M1 is turned off. At this time, the first node N1 maintains the voltage of the data signal supplied during the second period T2. Meanwhile, the width of the third period T3 is experimentally determined so that the voltage of the second node N2 increases up to the value corresponding to subtracting the threshold voltage of the second transistor M2 from the first power ELVDD. In other words, some embodiments of the present invention have an advantage in that it is possible to set a compensation period of a threshold voltage by adjusting the width of the third period T3, that is, the width of the control signal supplied to the control line CLn so that it is sufficiently wide. T3 may even overlap, wholly or partially, the horizontal periods of one or more succeeding rows.

Meanwhile, since the first node N1 is set to a floating state during the third period T3, there is a concern that the voltage of the first node N1 will change to correspond to an increase of the voltage of the second node N2. In some embodiments of the present invention, the second capacitor C2 is formed to have a larger capacitance than that of the first capacitor C1 in order to prevent the voltage of the first node N1 from being significantly changed. Actually, when the second capacitor C2 has a much larger capacitance than that of the first capacitor C1, the voltage of the first node N1 is not substantially changed during the third period T3.

During a fourth period T4, supplying the control signal to the control line CLn is stopped. When supplying the control signal to the control line CLn is stopped, the third transistor M3 is turned off. At this time, the first node N1 and the second node N2 maintains the voltages supplied during the third period T3.

During a fifth period T5, supplying the emission control signal to the emission control line En is stopped. When supplying the emission control signal to the emission control line En is stopped, the fourth transistor M4 and the fifth transistor M5 are turned on.

When the fourth transistor M4 is turned on, the voltage of the first node N1 is changed from the voltage of the data signal to the voltage of the reference power Vref. Thereafter, it is assumed that the voltage of the first node N1 decreases from the voltage of the data signal to the voltage of the reference power Vref. When the voltage of the first node N1 decreases, the voltage of the second node N2 also decreases to correspond to the decreased voltage of the first node N1. Thereafter, the second transistor M2 supplies current corresponding to the voltage applied to the second node N2 to the organic light emitting diode OLED via the fifth transistor M5.

Meanwhile, the voltage of the data signal is set to a voltage higher than the voltage of the reference power Vref at the time of implementing a general (that is, non-black) gray level. In this case, a certain or predetermined gray level can be implemented while the voltage of the second node N2 decreases to correspond to the voltage decrease of the first node N1.

In addition, the voltage of the data signal is set to a voltage lower than the voltage of the reference power Vref when displaying black. Ideally, when the voltage of the second node N2 is set to the difference of the threshold voltage of the second transistor M2 from the first power ELVDD, the second transistor M2 is turned off. Then, when the data signal is supplied to have the same voltage as the reference power Vref, that is, the voltage of the first node N1 does not vary, black can be implemented. However, when the data signal is supplied to have the same voltage as the reference power Vref, the second transistor M2 may be turned on by leakage current, etc., such that it is difficult to implement black. Accordingly, in some embodiments of the present invention, black is displayed by setting the voltage of the data signal to a voltage lower than the voltage of the reference power Vref.

In the pixel according to the embodiment of FIGS. 2 and 3, it is possible to control the compensation period of the threshold voltage of the driving transistor by using the width of the control signal. This technique can be applied to various suitable types of driving including high-speed driving, as the control signal width can span many horizontal periods if necessary. Further, in some embodiments of the present invention, since a gray level is implemented by using a difference value between the reference power Vref and the data signal, it is possible to display an image having desired luminance regardless of a voltage drop of the first power ELVDD.

FIG. 4 is a diagram showing a second embodiment of the pixel shown in FIG. 1. When FIG. 4 is described, the same components as those of FIG. 2 refer to the same reference numerals and a detailed description thereof will be omitted.

Referring to FIG. 4, the pixel 140 includes an organic light emitting diode OLED and a pixel circuit 142′ for controlling the amount of current supplied to the organic light emitting diode OLED. The organic light emitting diode OLED generates light having certain or predetermined luminance to correspond to the amount of current supplied from the pixel circuit 142′.

The pixel circuit 142′ receives the data signal when the scan signal is supplied to the scan line Sn and charges voltage corresponding to the threshold voltage of the second transistor M2 during the period when the control signal is supplied to the control line CLn. Compared to the pixel circuit 142 in FIG. 2, the second capacitor C2 is deleted from the pixel circuit 142′ and a sixth transistor M6, formed between the first node N1 and the anode electrode of the organic light emitting diode OLED, is further provided in the pixel circuit 142′.

The sixth transistor M6 is connected between the first node N1 (that is, the second terminal of the first capacitor C1) and the anode electrode of the organic light emitting diode OLED, and turned on when the control signal is supplied to the control line CLn. When the sixth transistor M6 is turned on, the first node N1 and the anode electrode of the organic light emitting diode OLED are electrically connected to each other.

Meanwhile, an organic capacitor Coled, formed between the sixth transistor M6 and the second power ELVSS as shown in FIG. 4, represents a parasitic capacitance of the organic light emitting diode OLED. In general, in the organic light emitting diode OLED, the anode electrode, a hole transport layer, a light emitting layer, an electron transport layer, and a cathode electrode are superimposed on each other. Therefore, the organic light emitting diode OLED has a high parasitic capacitance (that is, organic capacitor). Actually, the organic capacitor Coled is formed to have a larger capacitance than that of the first capacitor C1.

Now an operation process of the pixel circuit 142′ is described referring to FIGS. 3 and 4. First, the scan signal is supplied to the scan line Sn and the control signal is supplied to the control line CLn during the first period T1. When the scan signal is supplied to the scan line Sn, the first transistor M1 is turned on. When the first transistor M1 is turned on, the data signal from the data line Dm is supplied to the first node N1.

When the control signal is supplied to the control line CLn, the third transistor M3 and the sixth transistor M6 are turned on. When the sixth transistor M6 is turned on, the organic capacitor Coled and the first node N1 are electrically connected to each other. When the third transistor M3 is turned on, the second transistor M2 is diode connected. Meanwhile, during the first period T1, since the fifth transistor M5 remains turned on, the voltage of the second node N2 is initialized to substantially the voltage of the second power ELVSS.

During the second period T2, the emission control signal is supplied to the emission control line En. When the emission control signal is supplied to the emission control line En, the fourth transistor M4 and the fifth transistor M5 are turned off.

When the fourth transistor M4 is turned off, the first node N1 is set to the voltage of the data signal. When the fifth transistor M5 is turned off, electrical connection between the second node N2 and the organic light emitting diode OLED is blocked. Then, since the second transistor M2 is diode connected, the voltage of the second node N2 increases up to a value corresponding to subtracting the threshold voltage of the second transistor M2 from the first power ELVDD.

During the third period T3, supplying the scan signal to the scan line Sn is stopped. When supplying the scan signal to the scan line Sn is stopped, the first transistor M1 is turned off. During the third period T3, the voltage of the second node N2 increases up to the value corresponding to subtracting the threshold voltage of the second transistor M2 from the first power ELVDD. In addition, the first node N1 that is set to the floating state during the third period T3 maintains the voltage of the data signal supplied during the second period T2. In other words, since the organic capacitor Coled has a larger capacitance than the first capacitor C1, even though the voltage of the second node N2 is changed, the voltage of the first node N1 is not substantially changed.

During the fourth period T4, supplying the control signal to the control line CLn is stopped. When supplying the control signal to the control line CLn is stopped, the third transistor M3 and the sixth transistor M6 are turned off. At this time, the first node N1 and the second node N2 maintain the voltages supplied during the third period T3.

During the fifth period T5, supplying the emission control signal to the emission control line En is stopped. When supplying the emission control signal to the emission control line En is stopped, the fourth transistor M4 and the fifth transistor M5 are turned on.

When the fourth transistor M4 is turned on, the voltage of the first node N1 is changed from the voltage of the data signal to the voltage of the reference power Vref. At this time, the voltage of the second node N2 also decreases to correspond to the voltage variation of the first node N1. Thereafter, the second transistor M2 supplies current corresponding to voltage applied to the second node N2 to the organic light emitting diode OLED via the fifth transistor M5.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A pixel, comprising:
an organic light emitting diode having a cathode electrode coupled to a second power source;
a second transistor for controlling an amount of current to the organic light emitting diode from a first power source;
a first capacitor having a first terminal coupled to a gate electrode of the second transistor;
a first transistor coupled between a second terminal of the first capacitor and a data line, and configured to be turned on when a scan signal is supplied to a scan line; and
a third transistor coupled between the gate electrode and a second electrode of the second transistor, and configured to be turned on when a control signal is supplied to a control line,
wherein the third transistor is configured to remain turned on for a time longer than a time when the first transistor is configured to be turned on.

2. The pixel of claim 1, wherein the third transistor is configured to be concurrently turned on with the first transistor.

3. The pixel of claim 1, further comprising:
a fourth transistor coupled between a reference power source and the second terminal of the first capacitor, and is configured to remain turned on during a part of a period when the third transistor is configured to be turned on; and
a fifth transistor coupled between the second transistor and the organic light emitting diode, and configured to be turned on and turned off substantially simultaneously with the fourth transistor.

4. The pixel of claim 3, wherein the fourth transistor is configured to remain turned on during a part of a period when the first transistor and the third transistor are both turned on, and configured to be turned off during remaining periods except during a part of a period when the third transistor is configured to be turned off.

5. The pixel of claim 4, wherein the fourth transistor is configured to be turned on after the third transistor is configured to be turned off.

6. The pixel of claim 1, further comprising:
a second capacitor coupled between the second terminal of the first capacitor and the first power source.

7. The pixel of claim 6, wherein the second capacitor has a larger capacitance than the first capacitor.

8. The pixel of claim 3, further comprising:
a sixth transistor coupled between the second terminal of the first capacitor and an anode electrode of the organic light emitting diode, and configured to be turned on and turned off substantially simultaneously with the third transistor.

9. The pixel of claim 8, wherein the first capacitor has a smaller capacitance than a parasitic capacitance of the organic light emitting diode.

10. An organic light emitting display device, comprising:
a scan driver for sequentially supplying a scan signal to scan lines and sequentially supplying an emission control signal to emission control lines;
a control line driver for sequentially supplying a control signal having a width larger than the scan signal to control lines;
a data driver for supplying data signals to data lines to be synchronized with the scan signal; and
pixels at crossing regions of the scan lines and the data lines,
wherein each of the pixels comprises:
an organic light emitting diode having a cathode electrode coupled to a second power source;
a second transistor for controlling an amount of current to the organic light emitting diode from a first power source;
a first capacitor having a first terminal coupled to a gate electrode of the second transistor;
a first transistor coupled between a second terminal of the first capacitor and one of the data lines, and configured to be turned on when the scan signal is supplied to one of the scan lines; and
a third transistor coupled between the gate electrode and a second electrode of the second transistor, and configured to be turned on when the control signal is supplied to one of the control lines,
wherein for a natural number i, the control line driver is configured to supply the scan signal to an i-th scan line of the scan lines and is configured to supply the control signal to an i-th control line of the control lines.

11. The organic light emitting display device of claim 10, wherein the scan driver is configured to supply the emission control signal to an i-th emission control line of the emission control lines to partially overlap the scan signal supplied to the i-th scan line, and to stop supplying the emission control signal to the i-th emission control line after the control signal to the i-th control line is stopped.

12. The organic light emitting display device of claim 11, wherein each of the pixels further comprises:
a fourth transistor coupled between a reference power source and the second terminal of the first capacitor, and configured to be turned off when the emission control signal is supplied to one of the emission control lines; and
a fifth transistor coupled between the second electrode of the second transistor and the organic light emitting diode, and configured to be turned off when the emission control signal is supplied to the one of the emission control lines.

13. The organic light emitting display device of claim 12, wherein gray level voltages of non-black data signals are set to voltages higher than a voltage of the reference power source.

14. The organic light emitting display device of claim 12, wherein a gray level voltage of a black data signal is set to a voltage lower than a voltage of the reference power source.

15. The organic light emitting display device of claim 11, wherein each of the pixels further comprises:
a second capacitor coupled between the second terminal of the first capacitor and the first power source.

16. The organic light emitting display device of claim 15, wherein the second capacitor has a larger capacitance than the first capacitor.

17. The organic light emitting display device of claim 11, wherein each of the pixels further comprises:
a sixth transistor coupled between the second terminal of the first capacitor and an anode electrode of the organic light emitting diode, and configured to be turned on when the control signal is supplied to the one of the control lines.

18. The organic light emitting display device of claim 17, wherein the first capacitor has a smaller capacitance than a parasitic capacitance of the organic light emitting diode.
